(19) United States
(12) Patent Application Publication
(10) Pub. No.: US 2006/0124901 A1
(43) Pub. Date: Jun. 15, 2006

(54) Method for preparing high brightness luminescent material and high brightness luminescent material

(75) Inventors: Chaonan Xu, Saga (JP); Keiko Nishikubo, Saga (JP); Shuxiu Zhang, Saga (JP); Michio Obata, Saga (JP); Hiroaki Tanno, Saga (JP)

Correspondence Address: DARBY & DARBY P.C., P. O. BOX 5257, NEW YORK, NY, 10150-5257, US

(73) Assignee: National Institute of Advanced Industrial Science and Technology, Tokyo (JP)

(21) Appl. No.: 10/542,999

(22) PCT Filed: Dec. 26, 2003
(86) PCT No.: PCT/JP03/17095

§ 371 Date: Jul. 20, 2005

(30) Foreign Application Priority Data
Jan. 20, 2003 (JP) 200311518

(51) Int. Cl. C09K 11/77

(52) U.S. Cl. 252/301.4 R

(57) ABSTRACT

A method for preparing fine particles of a high brightness luminescent material improved in crystallinity; and a high brightness luminescent material prepared by the method. In an embodiment, BaMgAl₁₀O₁₇:Eu (BAM) as a high brightness luminescent material is prepared by a method which comprises providing an aqueous solution containing an aluminum alcoholate and water-soluble compounds of barium, magnesium and europium, adding an acid to the aqueous solution to form an acidic solution, heating the acidic solution to ca.900° C. and conducting a calcination at the temperature for a short time, and subsequently, firing the calcined product at a temperature higher than that for the calcination, for example, 1400° C. or higher. The method allows the preparation of BAM which comprises spherical fine particles having a pure phase and being improved in crystallinity, and thus is reduced in the deterioration by heat or VUV.

### BACKGROUND TO THE INVENTION

1. Technical Field

The present invention relates to a method for producing a high brightness luminescent material and a high brightness luminescent material. Described in more detail, the present invention relates to a high brightness vacuum ultraviolet (VUV)-excited luminescent material and a method for producing the same. This high brightness VUV-excited luminescent material is used in a phosphor layer of a plasma display panel and emits light when irradiated with vacuum ultraviolet radiation.

2. Background Art

With the arrival of the information age, there has been greater demand for large flat displays which are thin and flat. There has been much attention given to plasma display panels (PDP). PDP's are well-suited for image display of digital data such as in wall-mounted TV's, multimedia displays, and the like.

As a result, much research relating to PDP's has been conducted worldwide. Japan has been a world leader in PDP development, and Japan has over 80% of the world's share of PDP's. The production volume of PDP's in 2001 exceeded 200,000 units; in 2002, it exceeded 400,000 units; and in 2005, it is predicted to have a market scale of 6,000,000 units.

In general, PDP's have two glass substrates which are placed parallel and opposite each other. Between the two glass substrates, there are many electric discharge cells. These cells are partitioned by partitioning walls and have rare gas such as Ne and Xe and the like sealed in them. Of the two glass substrates, the glass plate on the observer side of the PDP is the front plate, and the other glass plate is the back plate. An electrode is formed on the front plate on the side towards the back plate. A dielectric layer surrounds this electrode. On top of the dielectric layer, a protective layer (MgO layer) is formed. On the front plate side of the back plate, an address electrode is formed so that it intersects with the electrode formed on the front plate. In addition, a phosphor layer is provided covering the back plate (corresponds to the bottom surface of the cell) and the wall surface of the partitioning wall. By applying alternating current voltage between the electrodes, vacuum ultraviolet radiation is generated by the electric discharge, and as a result of the vacuum ultraviolet radiation, the phosphor emits light. The visible light transmitted through the front plate is observed by the viewer.

In the prior art, the luminescent material used in the phosphor layer of PDP's are produced by a solid phase reaction method. Described more concretely, in the solid phase reaction method, each of the raw materials is mixed in a powder form in order to produce the prescribed composition. This is calcined at a high temperature of 1600 degrees C. or greater, and there is a solid phase reaction between each of the raw materials to produce the desired luminescent material.

In the solid phase reaction method, in order to accelerate the reaction, a flux agent, which becomes the liquid phase when calcining at high temperatures, is added. Examples of flux agents include aluminum fluoride, boric acid, sodium hydroxide, ammonium chloride, and the like.

However, in general, particles of luminescent material produced by the solid phase reaction method tend to be coarse, and fine particles of luminescent material are difficult to produce.

In order to solve this problem, fine particles of luminescent material are produced by reacting each of the materials for the luminescent material in an organic solvent. However, the luminescent material achieved by this method has low crystallinity, and adequate luminescent brightness is not achieved.

In order to solve the problems of the solid phase reaction method and the organic solvent reaction method, a method for producing a high brightness luminescent material is disclosed in the following Patent reference 1. Stated more concretely, a gel solution is prepared by making an alkaline solution by adding aqueous ammonia to an aqueous solution of triisopropoxyaluminum, strontium nitrate, europium nitrate, and boric acid. Next, dimethyl formamide is added and mixed with the gel solution. This is then dried at 150 degrees C. Next, preliminary calcination of this dried substance is conducted at 700 degrees C. in an oxidizing atmosphere. The resulting preliminary calcination substance is pulverized. A main calcination is then conducted at 1300 degrees C. in argon containing 5% by volume of hydrogen. In this manner, SrAl₂O₄ which does not contain any impurities and which has an average particle size of 1.5 micrometer is produced.

Patent Reference 1

Japanese Laid Open Patent Publication Number 2002-220587 (Publication Date: Aug. 9, 2002)

In general, PDP's have a lower luminous efficiency as compared to CRT's, and power consumption is high. As a result, in order to have a higher brightness and lower power consumption, PDP's with higher luminous efficiency are needed.

Therefore, in order to heighten the luminous brightness of PDP's, there is a desire to improve the luminous efficiency of the VUV-excited luminescent material.

In PDP's, the VUV-excited luminescent material is used in a phosphor layer in which a luminescent material film is formed. Stated more concretely, a binder resin is added to a VUV-excited luminescent material and made into a coating material. After painting uniformly onto a substrate, this is heated in air, and with thermal decomposition of the binder, the phosphor layer is formed.

It is known that the luminous intensity of the phosphor layer is generally lower than the luminous intensity of the VUV-excited luminescent material particles. One reason for this is that when treating with heat to form the phosphor layer, there is oxidation of the activator (luminescent center) of the VUV-excited luminescent material. For example, with BAM, which is used as a blue phosphor for PDP's, the activator Eu²⁺ is oxidized to Eu³⁺. This phenomenon is known as heat degradation or baking degradation.

In addition, in PDP'S, the VUV-excited luminescent material emits light by having continuous irradiation with vacuum ultraviolet radiation from a Xe gas discharge plasma. Because of this, the luminous intensity of the phosphor layer decreases over time because of the vacuum ultraviolet irradiation. This phenomenon is called VUV deterioration.

Therefore, even if a high brightness luminescent material is used as the VUV-excited luminescent material, if the heat degradation and VUV deterioration is large, this cannot be used as a phosphor layer of a PDP.

In order to improve the luminous efficiency, there must be simultaneously a reduction in the particle size of the VUV-excited luminescent material and improvement in the crystallinity of the phosphor. The VUV-excited luminescent material particles of the prior art contain impurities, and therefore, their purity is low. Because of this, stable crystal structures are not formed. As a result, they are unstable with respect to heat and vacuum ultraviolet radiation, and this is thought to cause heat degradation and VUV deterioration.

In PDP's, europium-activated barium magnesium aluminate, represented as BaMgAl₁₀O₁₇:Eu (henceforth referred as BAM), has an especially large heat degradation and VUV deterioration. BAM is the only phosphor used in the blue phosphor layer, however since heat degradation and VUV deterioration is large, improvement is needed.

As described previously, a method for producing a high brightness luminescent material is disclosed in Patent reference 1. However, there are no examples for producing BAM. In addition, when BAM is produced under alkaline conditions according to this method, a high calcination temperature of 1600 degrees C. or greater is needed in order to obtain a pure phase of BAM. As a result, heat degradation of BAM resulting from high temperatures occurs, and the luminous intensity is decreased.

### OBJECT AND SUMMARY OF THE INVENTION

The present invention considers the problems of the prior art. The object of the present invention is to improve the crystallinity of a high brightness luminescent material. A further object of the present invention is to reduce heat degradation and VUV deterioration and to provide a method for producing a high brightness luminescent material that is suitable for use in phosphor layer of PDP's and the like.

The present inventors have conducted intensive research into improving crystallinity of high brightness luminescent material. As a result, the present inventors discovered that spherical particles of high brightness luminescent material with improved crystallinity are obtained by a method in which, after making an acidic solution of a solution containing aluminum alcoholate as the raw material for producing high brightness luminescent material and another metal compound, a preliminary calcination of the acidic solution is conducted, and then a main calcination is conducted. This discovery led to the completion of the present invention.

In other words, in order to solve the above problems, the method for producing the high brightness luminescent material of the present invention is a method for producing a high brightness luminescent material constructed from a matrix substance containing alumina and a luminescence center of a rare earth metal ion and/or transition metal ion. This method comprises the following steps: a step for making an acidic solution from a solution of an water-based solvent containing aluminum alcoholate, which is the raw material for alumina, and a metal compound of a rare earth metal and/or transition metal, which is the raw material for the luminescence center; a step for conducting preliminary calcination by heating the acidic solution under oxidation conditions to a temperature of 900-1100 degrees C.; and a step for conducting a main calcination in which the preliminary calcination product obtained by preliminary calcination is pulverized, and under reducing conditions, main calcination is conducted by heating to a temperature higher than the temperature of the preliminary calcination.

According to the above construction, by making an acidic solution from a solution of a water-based solvent containing raw material for alumina and the luminescence center, the solution gelatinizes, or in other words becomes a sol-gel. Next, by conducting preliminary calcination of this solution, the water-based solvent is removed, and particles of luminescent material of approximately spherical shape are obtained. By conducting a main calcination on the approximately spherical-shaped particles obtained from preliminary calcination at a temperature higher than that of the preliminary calcination, the crystallinity of the luminescent material is improved while maintaining the particle size. The high brightness luminescent material is produced in this way.

In addition, the high brightness luminescent material obtained by the above construction has improved crystallinity. As a result, it is more stable with respect to heat and ultraviolet radiation, for example. As a result, a high brightness luminescent material with reduced heat degradation and VUV deterioration is provided.

In the method for producing high brightness luminescent material of the present invention, the acidic solution described previously preferably has a pH of 1 or greater and 7 or less.

According to this, the main calcination can be conducted at a temperature lower than the 1600 degrees C. which is the calcination temperature of the prior art. In other words, with the present invention, high brightness luminescent material which may degrade at high temperatures can be produced.

In the method for producing a high brightness luminescent material of the present invention, the calcination temperature of the main calcination is preferably 1400 degrees C. or greater and 1600 degrees C. or less.

According to this, a high brightness luminescent material is produced by calcination at approximately 1400 degrees C., which is a lower calcination temperature as compared to the prior art.

In the method for producing a high brightness luminescent material of the present invention, the metal compound described previously is preferably a nitrate.

According to this, the preliminary calcination can be conducted under reducing conditions. Therefore, even if the high brightness luminescent material is easily degraded by oxidation, production is possible while reducing degradation.

In the method for producing a high brightness luminescent material of the present invention, the luminescence center described previously preferably contains at least one type of metal selected from the group consisting of Eu, Pm, Pr, Yb, Ce, Nd, Tb, Gd, and Er.

These metals are used as a luminescent center in luminescent materials used in display devices such as PDP's for example. Therefore, with the above construction, an all-purpose high brightness luminescent material is produced.

In the method for producing a high brightness luminescent material of the present invention, the high brightness luminescent material described previously is preferably a BAM-type luminescent material represented as BaMgAl₁₀O₁₇:Eu. In other words, this is BaMgAl₁₀O₁₇:Eu (BAM) in which the matrix substance of the VUV-excited luminescent material described previously is BaMgAl₁₀O₁₇ and the luminescent center ion is Eu²⁺.

The BAM-type luminescent material is the only material that has been put into practical use as a blue phosphor for PDP's. However, it has the problem of having a large amount of heat degradation and VUV deterioration.

According to the above construction, the crystallinity of the luminescent material is improved, and a BAM type luminescent material with reduced heat degradation and VUV deterioration is provided.

In the method for producing high brightness luminescent material, a flux agent or a thickener is preferably added to the solution of the aforementioned water-based solvent. For example, aluminum fluoride, ammonium fluoroborate (NH₄BF₄), boric acid, and the like as a flux agent, and PVA and the like as a thickener are preferably added.

For the flux agent, preferably NH₄BF₄ is added. According to this, the resulting high brightness luminescent material has further improved crystallinity.

The flux agent accelerates the formation of a liquid phase at high temperatures, and in addition, the flux agent acts as a reaction catalyst. In addition, the thickener has a role in accelerating the crystallization of luminescent fine particles.

Therefore, by adding the flux agent and thickener, the crystallinity of the high brightness luminescent material is further improved. As a result, a high brightness luminescent material with reduced effects from heat degradation and VUV deterioration is produced. The high brightness luminescent material can be used in the phosphor layer of a PDP, for example. This results in a plasma display panel with an improved brightness.

In order to solve the problems described above, the high brightness luminescent material of the present invention is obtained by the method for producing a high brightness luminescent material of the present invention.

According to the above construction, because the crystallinity of the high brightness luminescent material is improved, a high brightness luminescent material with reduced heat degradation and VUV deterioration is provided.

The high brightness luminescent material of the present invention is preferably excited by vacuum ultraviolet radiation.

According to this, a high brightness luminescent material and in particular a VUV-excited luminescent material suitable for a phosphor layer in a PDP is provided.

### BRIEF DESCRIPTION OF THE FIGURES

FIG. 1 is a graph showing the luminescent brightness and luminescence spectrum of the BAM produced by Embodiment 1 and the comparative example.

FIG. 2 shows a XRD pattern of BAM produced by Embodiment 1 and the comparative example.

### DESCRIPTION OF THE PREFERRED EMBODIMENTS

One mode of implementation of the present invention is described below. The present invention is not limited to this.

The method for producing a high brightness luminescent material of the present invention produces fine particles of high brightness luminescent material with improved crystallinity.

First, the high brightness luminescent material produced by the method for the present invention is described. The high brightness luminescent material produced by the method of the present invention is an alumina type luminescent material constructed from a matrix substance containing at least aluminate (Al₂O₃) and a luminescent center.

In addition to alumina, the matrix substance described above can contain metal oxides other than aluminum. For example, oxides of alkali metals, alkali earth metals, transition metals, and rare earth metals can also be included.

Stated more concretely, the matrix substance can contain the following: an aluminate represented by the following general formula (1)
M¹ₓM²_{y}Al₂O_{(2x+2y+3z})/2 (1)
(In the formula, M¹ and M² are an alkaline earth metal such as Ca, Mg, Ba, Sr; rare earth metal such as Sc, Y, La, Ce, Pr, Nd, Pm, Sm, Eu, Gd, Tb, Dy, Ho, Er, Tm, Yb, Lu; transition metal such as Sb, Ti, Zr, V, Cr, Mn, Fe, Co, Ni, Cu, Zn, Nb, Mo, Ta, W. In addition, a portion of M¹ and M² can be substituted with at least one type of metal selected from a group consisting of alkali metals such as Li, Na, K, Rb, Cs, Fr, and also Si, Al, In, Ga, Ge. The x, y, and z are integers.);
a compound represented by the following general formulas (2)-(6)
M³Al₈O₁₃ (2)
M³₄Al₁₄O₂₅ (3)
M³MgAl₁₀O₁₇ (4)
M³₄Al₂SiO₇ (5)
M³₄Mg₂Al₁₆O₂₇ (6)
(In the formula, M³ is at least one type of metal selected from a group consisting of Ca, Ba, Sr, and Mg.);
and a metal oxide compound such as SrO, MgO, ZrO₂, TiO₂, Y₃Al₅O₁₂, ZnO, LiAlO₂, CeMgAl₁₁O₁₉, and the like.

For the luminescent center (also called an activator) is formed from at least one type of rare earth metal or transition metal. Stated more concretely, for the activator, a rare earth metal such as Sc, Y, La, Ce, Pr, Nd, Pm, Sm, Eu, Gd, Tb, Dy, Ho, Er, Tm, Yb, Lu, and the like, and preferably Eu, Tm, Nd, Gd, Tb, or a transition metal such as Sb, Ti, Zr, V, Cr, Mn, Fe, Co, Ni, Cu, Zn, Nb, Mo, Ta, W, and the like, and preferably Mn, Fe, Cu is used.

The type of color emitted by the high brightness luminescent material changes depending on the type of luminescent center. For example, in PDP's, there are Eu²⁺-activated blue luminescent materials having a luminescent center of Eu²⁺, Mn²⁺-activated green luminescent materials and Tb³⁺-activated green luminescent materials having a luminescent center of Mn²⁺ and Tb³⁺, and Eu³⁺-activated red luminescent material having a luminescent center of Eu³⁺.

Next, the method for producing the high brightness luminescent material of the present invention is described. The present production method produces an aluminate type luminescent material described above. The high brightness luminescent material is produced by making an acidic solution of a solution containing metal compounds which are the raw materials for the high brightness luminescent material and then conducting calcination. Stated more concretely, the method of the present invention includes the following steps (a)-(c):

(a) A step for making an acidic solution from a solution of a water-based solvent containing aluminum alcoholate and a rare earth metal ion and/or transition metal ion which is to be the central ion of the luminescent center.

(b) A step for conducting a preliminary calcination of the acidic solution under an oxidizing atmosphere.

(c) A step in which the preliminary calcination product is pulverized and a main calcination is conducted under a reducing atmosphere.

In step (a), first, with raw material of a metal compound which becomes a metal oxide in the subsequent calcination step, a solution of a water-based solvent is made. According to this, a metal ion solution which constitutes the high brightness luminescent material is formed.

Stated more concretely, for the alumina which is included as a matrix substance, aluminum alcoholate is used as the raw material. Examples include monomethoxydiethoxy aluminum, triethoxy aluminum, monopropoxydiethoxy aluminum, tripropoxy aluminum, triisopropoxy aluminum, and the like. However, the aluminum alcoholate is not limited to these.

Compounds other than alcoholate can be used to obtain alumina by calcination. For example, inorganic salts such as oxides, halides (for example chloride), hydroxides, carbonates, sulfates, nitrates, and the like, and organic compounds such as acetates, maleates, citrates, and the like of aluminum can be used.

If a metal oxide other than alumina is included in the matrix substance, a compound of the aforementioned metals (alkaline earth metal, transition metal, rare earth metal) is used as raw material. For example, inorganic salts such as oxides, halides (chloride, for example), hydroxides, carbonates, sulfates, nitrates, and the like, and organic compounds such as acetates, maleate alcoholates, and the like of the corresponding metal are used. These compounds are not limited.

In addition, for the raw material of the luminescent center, an inorganic salt such as oxide, halide (chloride for example), hydroxide, carbonate, sulfate, nitrate, and the like, and organic compound such as acetate, alcoholate, and the like of the corresponding rare earth metal or transition metal is used. This is not limited to these compounds.

For each of the raw materials, metal nitrates which are inexpensive and which readily decompose by heat are preferred. If nitrates are used for each of the raw materials, the subsequent preliminary calcination can be conducted under a reducing atmosphere. As a result, when producing luminescent material which may degrade by oxidation, the use of nitrates of the metals is preferred for the raw materials.

The amounts of these raw materials to be used correspond to the ratios of the metal components of the high brightness luminescent material, or in other words, to the constituent atomic ratios of each of the metal components of the matrix substance and luminescent center.

For the solvent of the metal ion solution of the metal compounds of these raw materials, a water-based solvent, such as water or a mixture of water and a water-miscible solvent, for example an alcohol solvent such as ethyl alcohol and the like, a ketone solvent such as acetone and the like, is used. The overall metal ion concentration is not limited, however, it is normally within a range of 0.0001-10 mol/L.

For the above solvent, from the standpoint of safety, handling, and the environment, water is preferred. For example, in order to perform efficiently as the luminescent center, the alkali earth ion in the luminescent material must be substituted uniformly. When water is used as the solvent, there is adequate mixing of rare earth ions with alkali earth ions at a molecular level. As a result, the addition of the luminescent center and grid defects are efficiently controlled.

Next, an acid or base is added to the liquid of the metal ion solution obtained as above, and the solution is made acidic. With this, the metal ion solution becomes gelatinized, or in other words, it becomes a sol gel solution. Although the metal ion solution needs only to be acidic, it preferably has a pH of 1 or greater and 7 or less, and more preferably a pH of 3 or greater and 6 or less. By making the liquid of the metal ion solution acidic, the subsequent calcination can be conducted at a low temperature of approximately 1400 degrees C.

In addition, when producing BAM, by having the raw material metal ion solution a pH of 6, the luminous intensity of BAM is particularly high. Even without adding a flux agent as described later, a pure phase BAM is produced.

There are no particular limitations as to the acid or base which is added to the metal ion solution to make it acidic. For example, inorganic acids such as hydrochloric acid, sulfuric acid, boric acid, and the like, and organic acids such as acetic acid, citric acid, maleic acid, and the like can be used. For the base, aqueous ammonia and the like can be used, for example. The acid or base which is added is preferably one that has a boiling point which is lower than the subsequent calcination temperature. With this, the acid and base are removed from the luminescent material through calcination.

In addition, when adjusting the pH of the metal ion solution, the use of aqueous ammonia is preferred. Thermal decomposition readily occurs with aqueous ammonia. The preliminary calcination product does not have to be rinsed. As a result, a production step can be eliminated. In addition to greatly shortening the production time, this is a production method which takes the environment into consideration as well.

Next, in step (b), preliminary calcination is conducted by heating the acidic solution of step (a) in an oxidizing atmosphere, for example in air. The heating temperature and heating time for the preliminary calcination will depend on the raw material composition and calcination temperature. However, it is at a lower temperature and shorter time than the subsequent main calcination. Stated more concretely, it is at a temperature of 600 degrees C. or greater and for a short time. For example, preliminary calcination is conducted from several seconds to less than one hour at a temperature of 600 degrees C.-1500 degrees C. With this, the solvent of the acidic solution is dried and removed. In addition, fine particles of high brightness luminescent material (preliminary calcination product) is obtained by thermal decomposition. The shape of the preliminary calcination product is approximately spherical.

Next, in step (c), after pulverizing the spherical particles of the preliminary calcination product of the high brightness luminescent material obtained by the preliminary calcination of step (b), the main calcination is conducted by heating in a reducing atmosphere such as argon diluted 4% hydrogen air current. With this, a luminescent material that is even brighter than the preliminary calcination product is obtained. With the production method of the present invention, by conducting a main calcination, the crystallinity of the luminescent material is improved without any tendency for the particles of luminescent material to become larger.

The heating temperature and heating time for the main calcination will depend on the raw material composition and heating temperature, but it is conducted at a temperature of approximately 1400 degrees C. to 1600 degrees C. for 0.1-6 hours. However, when producing a luminescent material that is easily degraded at high temperatures, it is preferable to conduct at a low temperature.

As described above, fine particles of high brightness luminescent material of approximately spherical shape are produced. The particle size of the high brightness luminescent material obtained by the present production method can be controlled to sub micrometer to several micrometers. If the particle size is small, the surface area is larger, and the luminous efficiency is higher. Therefore, the luminous intensity of the phosphor layer in a plasma display panel is increased, for example. With this, a plasma display panel which is even brighter is provided. Furthermore, when particles are smaller, the packing density is higher. The luminous intensity of the phosphor layer is improved, and the phosphor layer can be made thinner in order to reduce production costs.

Furthermore, the resulting high brightness luminescent material is a single phase (pure phase) which does not contain impurities. In other words, it consists only of a phase in which the luminescent center is completely solid solubilized in the crystals of the matrix substance. As a result, the crystallinity of the luminescent material is improved, and a luminescent material that is brighter than that of the prior art is obtained. The reason for improved crystallinity of the luminescent material is thought to be because the rare earth metal and the transition metal which are the luminescent centers are uniformly surrounded by the matrix substance. As a result, even though the particle size is small, it is a luminescent material with high crystallinity. A luminescent material which is brighter than that of the prior art is achieved.

Furthermore, because the crystallinity of the luminescent material is improved, the crystal structure is stable, and heat degradation and vacuum ultraviolet radiation deterioration are reduced, for example.

In this manner, the high brightness luminescent material obtained by the present method has improved crystallinity, and in particular, the dispersion of the luminescent center is good. In other words, the luminescent center in the luminescent material is efficiently incorporated into the matrix substance. With this, this high brightness luminescent material not only has a high brightness, it is stable with respect to heat and vacuum ultraviolet radiation. As a result, the heat degradation and VUV deterioration is reduced as compared to the prior art.

In step (a), in order to heighten the crystallinity of the fine particles, additives such as flux agents and thickeners can be added to the metal ion solution described above.

For example, aluminum fluoride, ammonium fluoroborate, boric acid, and the like as a flux agent and PVA and the like as a thickener can be added. The amount of additive is not limited, however around 0.001 mol %-100 mol % can be added.

In Step (a), the metal ion solution is made acidic. However, if the solution is made alkaline with a pH of 8 or greater, the heating temperature for the main calcination may require a high temperature of 1600 degrees C. or greater.

By adjusting the metal ion solution to acidic-alkaline, the particle shape of the luminescent material can be controlled to a flat shape, spherical shape, and network shape.

In addition, a dispersion stabilizing agent for stabilizing the dispersion of metal ions in the acidic solution can be added to the acidic solution of Step (a). For example, as a dispersion stabilizer, a dialkyl carboxylic amide such as dimethyl formamide, dimethyl acetamide, diethyl acetamide, and the like is added. With this, condensation of the sol gel particles during calcination is prevented, and the luminous brightness is improved.

By adding the dispersion stabilizer, the sol gel particles are coated, and condensation and enlargement of the crystal particles during high temperature calcination are suppressed. Even after high temperature calcination for 2 hours at 1500 degrees C., fine particles of 2 microns or less are obtained. As the dispersion emulsifier, the addition of dimethyl formamide is particularly effective. In addition, when adding the dispersion stabilizer, in order to prevent cross-linking reaction, it is preferable to stir vigorously.

By drying the resulting sol gel emulsified solution, gel particle powder having an approximately spherical shape is achieved. The drying is preferably conducted as rapidly as possible. For example, by setting the temperature of a drying oven to a temperature higher than the boiling point, an evaporation plate in which rapid drying is possible can be used. In addition, drying can be conducted by ultrasonic drying method, spray drying method, and the like.

After drying, approximately spherical fine particles of luminescent material (preliminary calcination product) are obtained by thermal decomposition (preliminary calcination). As with drying, the thermal decomposition is also preferably conducted rapidly.

In this manner, drying and preliminary calcination can be conducted separately. However, as described previously, drying and the preliminary calcination can also be conducted in the same step.

In addition, step (c) is preferably conducted in an atmosphere with an oxygen concentration of 0.2 ppm or less and a water content of 0.5 ppm or less. With this, the oxidation of high brightness luminescent material, which is a cause for heat degradation, is prevented.

As will be described in the embodiment, the method for producing high brightness luminescent material of the present invention is particularly suitable for producing BAM which can be used in the blue phosphor layer of a PDP. BAM is the only substance that has been in practical use as the blue phosphor layer. However, the bonding of the luminescent center Eu in the crystal of BAM is weak. As a result, the luminescent center Eu²⁺ is readily oxidized to Eu³⁺, and this results in large heat degradation and VUV deterioration.

In PDP's, full color display is realized by combining the three colors of red, green, and blue. If any one color deteriorates and has a lowered luminous brightness, an ideal image display is not realized.

The BAM that is in general use is represented by (Ba_{0.9}Eu_{0.1})MgAl₁₀O₁₇. It contains 10% Eu²⁺ ion as the luminescent center.

Therefore, the BAM produced by the method of the present invention can also contain Eu²⁺ ion at 10%. However, the amount of Eu²⁺ is not limited. Because rare earth metals are generally expensive, as long as an adequate luminous brightness can be ensured, the amount of rare earth metal is preferably low. By doing so, an inexpensive high brightness luminescent material is provided.

In general, if the particle size is large, the luminous brightness also increases because it is thought that the particles have grown. However, even if the particle size is large, if the crystallinity of the luminescent material particle is poor, the luminous brightness is low regardless of particle size. For example, with BAM, if the substitution of Ba and Eu in the crystal is not ideal, Eu does not sufficiently emit light, and the luminous brightness is lowered. Furthermore, heat degradation and VUV deterioration also become large.

The high brightness luminescent material of the present invention has improved crystallinity, and as a result the luminous brightness is high regardless of the particle size, and heat degradation and VUV deterioration are also reduced.

In addition, a reason for the poor luminous efficiency of BAM is thought to be because among the BAM constituents of Ba²⁺, Mg²⁺, Al³⁺, and Eu²⁺, Eu²⁺ which is the luminescent center has a particularly poor dispersion, and thus it cannot contribute to luminescence. In other words, the Ba in BaMgAl₁₀O₁₇ is substituted poorly with the luminescent center of Eu.

In addition, the crystal structure of the luminescent material is thought to be a reason for the large heat degradation and VUV deterioration of BAM. In other words, in BAM, the bonding of Eu is extremely weak, and this is hypothesized to be a reason why BAM readily deteriorates. When the crystallinity of BAM is poor, the Eu²⁺ ion, which is the luminescent center ion, is substituted poorly, and this results in poor stability and contributes poorly to luminescence.

The fine particles of high brightness luminescent material obtained by the method of the present invention are small at a particle size of 2 microns or less. As a result, the creation of a high resolution display is easy. In addition, the VUV-excited luminous intensity and stability are higher than in luminescent materials obtained from the prior art, and this is suitable for use in a PDP.

Known methods are used in order to produce a phosphor layer for a PDP from the high brightness luminescent material of the present invention. A binder resin is added to the high brightness luminescent material produced by the above method in order to make a coating material. After painting uniformly onto a substrate, the phosphor layer is produced by heat treatment in air to conduct thermal decomposition of the binder. This phosphor layer has a high luminous brightness, and a PDP with high brightness is produced.

As described above, the high brightness luminescent material of the present invention can be used as a VUV-excited luminescent material contained in the phosphor layer of a plasma display panel. In other words, the method for producing a high brightness luminescent material of the present invention can be said to be a method for producing a VUV-excited luminescent material. The high brightness luminescent material described above can be used in various luminescent materials, not just those excited by vacuum ultraviolet radiation, but also those excited by stress, ultraviolet radiation, plasma, electron beam, electric field, and the like.

The present invention is not limited to each of the implementation modes described above, but various changes can be made within the scope indicated by the claims. Different implementation modes in which the disclosed technical means are combined as suitable are also included within the technical scope of the present invention.

### EMBODIMENTS

The present invention is described below in detail based on the embodiments. The present invention is not limited to these embodiments.

In the following embodiments, heat degradation was evaluated as the rate of maintaining the luminous intensity after heat treatment of the coating film for 30 minutes at 500 degrees C. in air. In addition, VUV deterioration was evaluated as the maintenance rate of luminous intensity after 22 hours of irradiation in a plasma irradiation accelerated test tube.

### Embodiment 1

### Production of BaMgAl₁₀O₁₇:Eu

For the raw material, 0.5 mol of triisopropoxy aluminum, 0.045 mol of nitrate of barium (Ba(NO₃)₂), 0.05 mol of nitrate of magnesium (Mg(NO₃)₂), 0.005 mol of nitrate of europium (Eu(NO₃)₂) was added to 2L of distilled water to make a metal ion solution. While mixing this metal ion solution, aqueous ammonia (NH₃—H₂O) was added to achieve a pH of 5.0, and a sol-gel solution was formed. Next, preliminary calcination of the sol-gel solution was conducted by heating to 1100 degrees C. Next, the resulting preliminary calcination product was pulverized, and in a reducing atmosphere, a main calcination was conducted for 2 hours at 1500 degrees C. Fine particles of BAM of approximately spherical shape (average particle size of 1.5 microns) were obtained.

With the solid phase reaction method of the prior art, the particle size was 10 microns or greater. The particle size of the present invention was much smaller than that obtained by the method of the prior art.

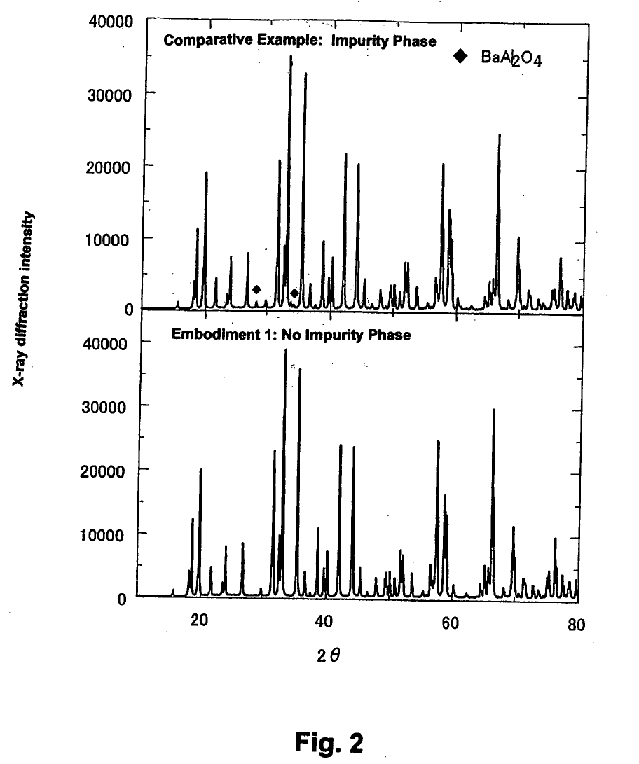

Referring to FIG. 2, an XRD pattern showing the crystal structure of BAM obtained by the present embodiment is shown. This does not contain any impurity phase and is a BAM with extremely high crystallinity. Compared to the results of the comparative example which was obtained by the solid phase method, the crystallinity of the present invention is clearly higher than that obtained by the solid phase reaction method.

In this manner, even though the particle size of the present embodiment was small, BAM of high crystallinity was obtained.

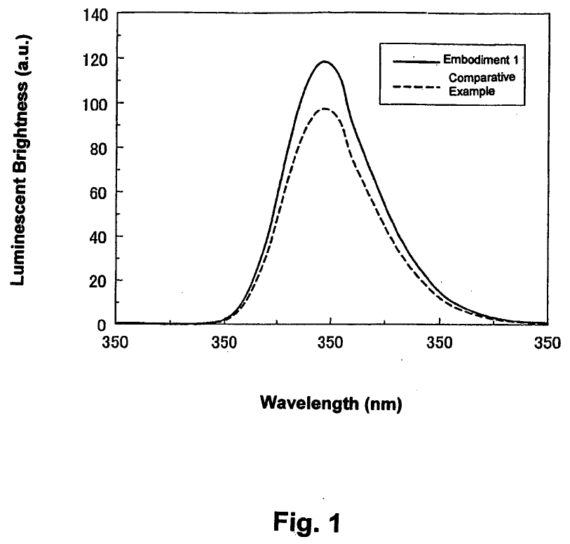

Referring to FIG. 1, a comparison of the VUV-excited luminous intensity is shown. As shown in FIG. 1, luminescent material with a higher luminous intensity than that of the solid phase reaction method was obtained.

### Embodiment 2

BAM was produced under acidic conditions by the same method as the method of Embodiment 1, except that 0.005 mol of ammonium fluoroborate (NH₄BF₄) was added to the metal ion solution as a flux agent and aqueous ammonia was added to achieve a pH of 4.0. As a result, BAM with an average particle size of 1.8 microns was obtained.

### Embodiment 3

BAM was produced under acidic conditions by the same method as the method in Embodiment 2, except that aluminum fluoride was added as the flux agent instead of ammonium fluoroborate. As a result, BAM with an average particle size of 2.0 microns was obtained.

### Embodiment 4

BAM was produced under acidic conditions by the same method as the method in Embodiment 2, except that boric acid was added as a flux agent instead of ammonium fluoroborate and the preliminary calcination temperature was 900 degrees C. As a result, BAM with an average particle size of 2.0 microns was obtained.

The luminous brightness, heat degradation, and VUV deterioration of the BAM produced in Embodiments 1-4 were evaluated, and the results are shown in Table 1.

TABLE 1

| | Luminous | Heat | VUV |
|---|---|---|---|
| Sample | Intensity | Degradation | Deterioration |
| Embodiment 1 | 120 | 65 | 45 |
| Embodiment 2 | 118 | 80 | 60 |
| Embodiment 3 | 114 | 70 | 55 |
| Embodiment 4 | 112 | 70 | 45 |
| Comparative | 100 | 60 | 30 |
| Example | | | |

Uses in Industry

As described above, the method for producing a high brightness luminescent material of the present invention comprises: a step for making an acidic solution from a solution of a water-based solvent containing aluminum alcoholate, which is the raw material for aluminate, and a metal compound of a rare earth metal and/or transition metal, which is the raw material for the luminescent center; a step for conducting a preliminary calcination by heating the acidic solution under oxidizing conditions to a temperature of 600 degrees C.-1100 degrees C.; a step for conducting a main calcination in which the calcination product obtained by the preliminary calcination is pulverized, and under reducing conditions, this is heated to a temperature higher than the heating temperature of the preliminary calcination.

As a result, the metal of the luminescent center in particular is dispersed uniformly, and the crystallinity of the high brightness luminescent material is improved. The high brightness luminescent material obtained by this method not only has high brightness, but also has reduced heat degradation and VUV deterioration. As a result, the high brightness luminescent material of the present invention is suitable for use in a phosphor layer of a PDP, for example, and can be provided as a VUV-excited luminescent material.

1. A method for producing a high brightness luminescent material which includes a matrix substance that contains aluminate and a luminescent center, which is a rare earth metal ion and/or transition metal ion, comprising:
a step for making an acidic solution of a solution of a water-based solvent containing aluminum alcoholate, which is raw material for aluminate and a metal compound of a rare earth metal and/or transition metal, which is raw material for said luminescent center;
a step for conducting a preliminary calcination of said acidic solution by heating between 900 degrees C.-1100 degrees C., inclusive, under oxidizing conditions; and
a step for conducting a main calcination in which calcination product obtained from said preliminary calcination is pulverized, and under reducing conditions, main calcination is conducted by heating to a temperature higher than the heating temperature of said preliminary calcination.

2. A method for producing a high brightness luminescent material according to claim 1, wherein:
pH of said acidic solution is between 1 and 7, inclusive.

3. A method for producing a high brightness luminescent material according to claim 1, wherein:
calcination temperature of said main calcination is 1400 degrees C. to 1600 degrees C., inclusive.

4. A method for producing a high brightness luminescent material according claim 1, wherein:
said metal compound is a nitrate.

5. A method for producing a high brightness luminescent material according to claim 1, wherein:
said luminescent center contains at least one type of metal selected from the group consisting of Eu, Pm, Pr, Yb, Ce, Nd, Tb, Gd, and Er.

6. A method for producing a high brightness luminescent material according to claim 1, wherein:
said high brightness luminescent material is a BAM type luminescent material represented by BaMgAl₁₀O₁₇:Eu.

7. A method for producing a high brightness luminescent material according to claim 1, wherein:
a flux agent or a thickener is added to said water-based solvent solution.

8. A method for producing a high brightness luminescent material according to claim 7, wherein:
NH₄BF₄ is added as said flux agent.

9. A high brightness luminescent material obtained by a method for producing a high brightness luminescent material according to claim 1.

10. A high brightness luminescent material according to claim 7, wherein:
said high brightness luminescent material is excited by vacuum ultraviolet radiation.
